(19) United States
(12) Patent Application Publication
(10) Pub. No.: US 2026/0064838 A1
(43) Pub. Date: Mar. 5, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Shota KIZUKURI, Tokyo (JP); Takahisa YUTOKU, Tokyo (JP); Yoshihiko KOIZUMI, Tokyo (JP)

(73) Assignee: NEC Corporation, Tokyo (JP)

(21) Appl. No.: 19/294,659

(22) Filed: Aug. 8, 2025

(30) Foreign Application Priority Data
Aug. 27, 2024 (JP) 2024-145702

(51) Int. Cl. G06F 21/55

(52) U.S. Cl. CPC G06F 21/554; G06F 2221/034

(57) ABSTRACT

An information processing apparatus includes a collection unit for inputting instruction information used to collect information related to a security incident, into a model that generates and outputs an answer based on an input instruction and causing the model to collect answer information related to the security incident and an extraction unit for extracting information indicating the security incident and information indicating an organization to be a subject of the security incident, based on the answer information.

### CROSS REFERENCE TO RELATED APPLICATION

This application is based upon and claims the benefit of priority from Japanese patent application No. 2024-145702, filed on Aug. 27, 2024, the disclosure of which is incorporated herein in its entirety by reference.

### TECHNICAL FIELD

The present disclosure relates to an information processing apparatus, an information processing method, and a computer-readable recording medium used for cyber security.

### BACKGROUND ART

To grasp an organization (for example, company, organization, or the like) related to a security incident and a type of the security incident, manpower and long time are needed. Therefore, a system is required that automatically grasps the organization related to the security incident and the type.

As related art, PTL 1 (JP 2022-527511A) discloses a system that extracts a plurality of security events, from a source data natural language text such as news articles, blogs, or tweets. The system in JP 2022-527511A extracts a security entity such as malware, a cybercriminal, or an indicators of compromise (IoC), by a machine learning technique.

However, the system in JP 2022-527511A does not efficiently collect information related to the security incidents, by using a generative artificial intelligence (AI). Specifically, the information related to the security incident is not collected by using a prompt.

### SUMMARY

An example of an object of the present disclosure is to efficiently collect information related to a security incident.

In order to achieve the above object, an information processing apparatus according to one aspect of the present disclosure includes
a collection unit for inputting instruction information used to collect information related to a security incident, into a model that generates and outputs an answer based on an input instruction and collecting answer information related to the security incident into the model and
an extraction unit for extracting information indicating the security incident and information indicating an organization to be a subject of the security incident, based on the answer information.

In order to achieve the above object, an information processing method according to one aspect of the present disclosure performed by an information processing apparatus, includes
inputting instruction information used to collect information related to a security incident, into a model that generates and outputs an answer based on an input instruction and collecting answer information related to the security incident into the model and
extracting information indicating the security incident and information indicating an organization to be a subject of the security incident, based on the answer information.

In addition, to achieve the above object, a computer-readable recording medium according to one aspect of the present disclosure causes a computer to execute processing including
inputting instruction information used to collect information related to a security incident, into a model that generates and outputs an answer based on an input instruction and collecting answer information related to the security incident into the model and
extracting information indicating the security incident and information indicating an organization to be a subject of the security incident, based on the answer information.

As described above, according to the present disclosure, it is possible to efficiently collect information related to a security incident.

### BRIEF DESCRIPTION OF THE DRAWINGS

FIG. 1 is a diagram for explaining an example of an information processing apparatus;

FIG. 2 is a diagram illustrating an example of a system including the information processing apparatus;

FIG. 3 is a diagram for explaining an example of content of instruction information;

FIG. 4 is a diagram for explaining an example of a user interface;

FIG. 5 is a diagram for explaining a filter screen, a keyword search screen, a word appearance frequency screen, and a transition screen;

FIG. 6 is a diagram for explaining a news display screen;

FIG. 7 is a diagram for explaining a security incident type screen and a news organization display screen;

FIG. 8 is a diagram for explaining a news detail display screen;

FIG. 9 is a diagram for explaining an operation of the information processing apparatus; and

FIG. 10 is a diagram for explaining an example of a computer that achieves the information processing apparatus according to an example embodiment.

### EXAMPLE EMBODIMENT

Hereinafter, an example embodiment will be described with reference to the drawings. In the drawings described below, elements having the same function or relevant functions are denoted by the same reference signs, and repeated description thereof may be omitted.

### Example Embodiment

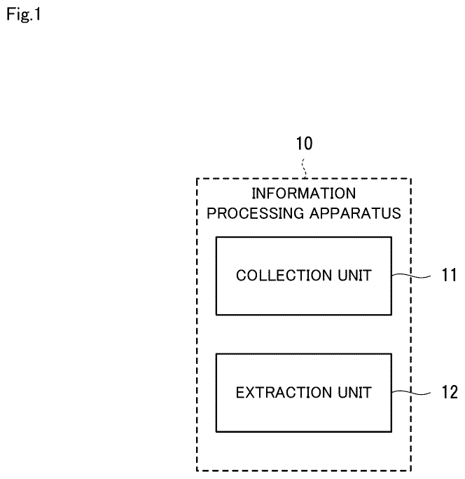

A configuration of an information processing apparatus 10 according to the example embodiment will be described, with reference to FIG. 1. FIG. 1 is a diagram for explaining an example of an information processing apparatus.

### [Device Configuration]

The information processing apparatus 10 illustrated in FIG. 1 is a device that efficiently collects information related to a security incident and presents the information to a user (a device that collects information related to a security incident: a security incident collection device or a device that collects and presents information related to a security incident: a security incident presentation device). As illustrated in FIG. 1, the information processing apparatus 10 includes a collection unit (collection means) 11 and an extraction unit (extraction means) 12.

The collection unit 11 inputs instruction information used to collect the information related to the security incident into a model that generates and outputs an answer based on an input instruction and causes the model to collect answer information related to the security incident.

The extraction unit 12 extracts information indicating the security incident and information indicating an organization to be a subject of the security incident, based on the answer information.

In this way, in the example embodiment, since the model is caused to collect the information related to the security incident, it is possible to efficiently collect the information related to the security incident.

### [System Configuration]

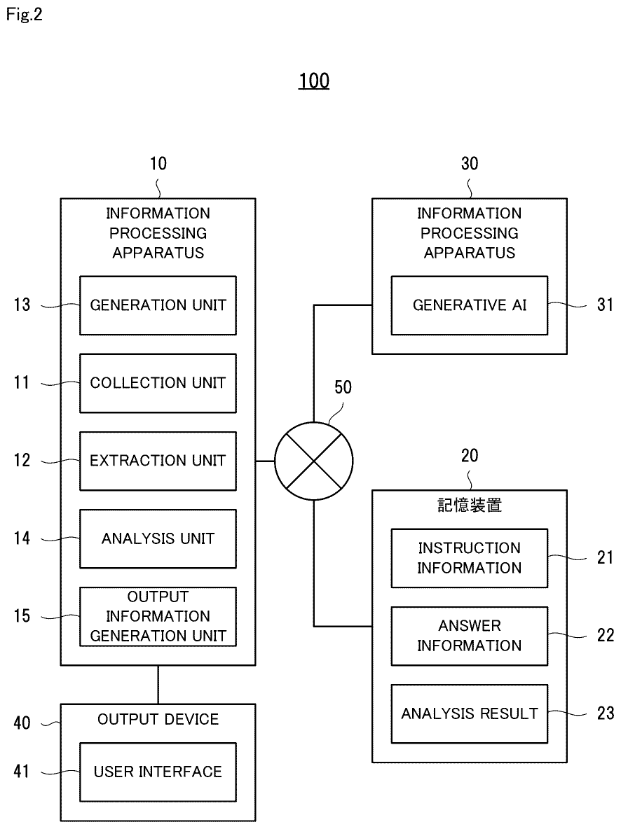

Subsequently, the configuration of the information processing apparatus 10 according to the example embodiment will be more specifically described, with reference to FIG. 2. FIG. 2 is a diagram illustrating an example of a system including the information processing apparatus.

As illustrated in FIG. 2, a system 100 according to the example embodiment includes the information processing apparatus 10, a storage device 20, an information processing apparatus 30, and an output device 40, and these are communicably connected via a network 50.

The information processing apparatus 10 is a circuit, a server computer, a personal computer, a mobile terminal, or the like equipped with, for example, a central processing unit (CPU), a programmable device such as a field-programmable gate array (FPGA), a graphics processing unit (GPU), or any one or more thereof.

The storage device 20 is a circuit or the like including a database, a server computer, and a memory. The storage device 20 stores various types of information to be described later (at least, the instruction information, the answer information, an analysis result, or the like) In the example in FIG. 2, although the storage device 20 is provided outside the information processing apparatus 10, the storage device 20 may be provided in the information processing apparatus 10.

The information processing apparatus 30 is, for example, a circuit, a server computer, a personal computer, or the like equipped with a CPU, a programmable device such as an FPGA, a GPU, or any one or more thereof, on which the model such as a generative AI 31 is mounted. However, in the example in FIG. 2, although the information processing apparatus 30 is provided outside the information processing apparatus 10, the information processing apparatus 30 may be provided in the information processing apparatus 10.

The generative AI 31 is an artificial intelligence system that generates information such as a new text, image, or sound, based on input information and outputs the information. As the generative AI, for example, ChatGPT, Gemini, Claude, Llama, and the like are used.

The output device 40 displays, at least, a user interface 41 used by the user for analysis. The output device 40 acquires output information to be described later, converted into a format that can be output and outputs the generated image, sound, or the like based on the output information. The output device 40 is, for example, an image display device or the like using liquid crystal, organic electro luminescence (EL), or a cathode ray tube (CRT). Moreover, the image display device may include, for example, a sound output device such as a speaker. The output device 40 may be a printing device such as a printer. In the example in FIG. 2, although the output device 40 is provided outside the information processing apparatus 10, the output device 40 may be provided in the information processing apparatus 10.

Network 50 is, for example, a general network constructed by using a communication line such as the Internet, a local area network (LAN), a dedicated line, a telephone line, an intra-company network, a mobile communication network, the Bluetooth (registered trademark), or the Wireless Fidelity (Wi-Fi) (registered trademark).

### The Information Processing Apparatus Will be Described in Detail.

The information processing apparatus 10 includes a generation unit 13, the collection unit 11, the extraction unit 12, an analysis unit 14, and an output information generation unit 15.

The generation unit 13 generates the instruction information used to collect the information related to the security incident. The instruction information includes, for example, a system message and a prompt. The user may generate the instruction information.

The system message is information representing context, an instruction, or the like related to a use case and is used to process a model in advance. The prompt includes determination condition information, subject extraction information, and type determination information, as information to be input into the generative AI 31.

The determination condition information is information used to determine whether a target incident is the security incident. The subject extraction information is information used to extract an organization to be a subject of the security incident. The type determination information is information used to determine a type of the security incident.

The type of the security incident is, for example, information leakage, a ransomware damage, a denial of service (DoS) attack damage, an unauthorized access, or the like.

Moreover, the prompt includes information used to extract a date and time when the security incident has occurred (occurrence date and time information) and information used to extract a date and time when an announcement regarding the security incident has been made (announcement date and time information), as the information to be input into the generative AI 31.

Moreover, the prompt includes format information for causing an answer of the generative AI 31 to be made in accordance with a preset format, as the information to be input into the generative AI 31.

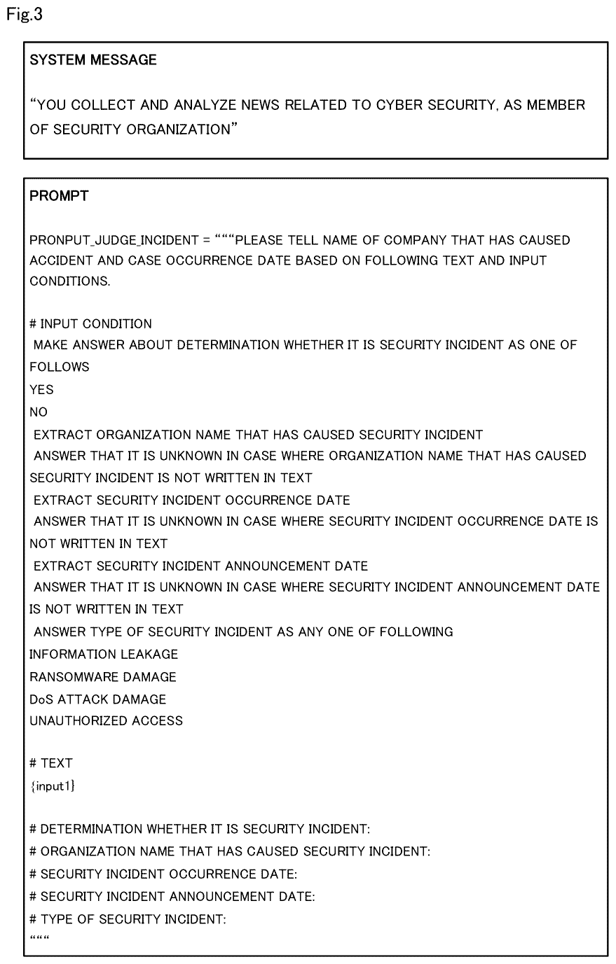

FIG. 3 is a diagram for explaining an example of content of the instruction information. In the example in FIG. 3, as the “system message”, it is described that “You collect and analyze news related to the cyber security, as a member of a security organization”.

In the example in FIG. 3, as the “prompt”, it is described that “Please tell a company name that has caused an accident and an accident occurrence date, based on the following text and input conditions”.

In addition, in the “prompt”, in order to specifically instruct answer content, the input conditions (the determination condition information, the subject extraction information, the type determination information, the occurrence date and time information, and the announcement date and time information) are described. In the example in FIG. 3, the “input conditions” are described as follows.
#Input Condition
Make an answer about determination whether it is a security incident as one of the follows
YES
NO
Extract an organization name that has caused the security incident
Answer that it is unknown in a case where the organization name that has caused the security incident is not written in the text
Extract a security incident occurrence date
Answer that it is unknown in a case where the security incident occurrence date is not written in the text
Extract a security incident announcement date
Answer that it is unknown in a case where the security incident announcement date is not written in the text
Answer the type of the security incident as any one of the following
information leakage
ransomware damage
DoS attack damage
unauthorized access

In addition, in the “prompt”, in order to reduce a difference in the answer of the generative AI 31, information for specifying a format of an answer sentence (format information) is described. In the example in FIG. 3, the “format information” is described as follows. The difference in the answer is caused depending on whether an item (“#” or “:”) is included, whether a value is described in the same row, or the like.
#Determination on whether it is a security incident: #Organization name that has caused the security incident:
#Security incident occurrence date:
#Security incident announcement date:
#Type of security incident:

In {input1}, information to be a base of the determination of the input condition, for example, information such as a body text of the news or an abstract of the news text is input.

First, the collection unit 11 inputs the instruction information used to collect the information related to the security incident, into the model such as the generative AI 31. When the instruction information is input, the generative AI 31 generates the answer information, for example, from the information such as the body text of the news or the abstract of the news text.

Next, the collection unit 11 collects the answer information related to the security incident generated by the model, from the model such as the generative AI 31. Specifically, the collection unit 11 acquires the answer information generated based on the format of the answer sentence from the generative AI 31 and stores the answer information in the storage device 20.

First, the extraction unit 12 acquires the answer information from the collection unit 11 or the storage device 20. Next, the extraction unit 12 extracts an answer for each item, from the acquired answer information. The extraction unit 12 stores the extracted answer (extracted information) in the storage device 20.

In a case where the format information in FIG. 3 is used, answers for the items in the answer information “#Determination on whether it is a security incident:”, “#Organization name that has caused the security incident:”, “#Security incident occurrence date:”, “#Security incident announcement date:”, and “#Type of security incident:” are extracted.

In addition, the extraction unit 12 executes morpheme analysis processing on the extracted answer (extracted information), segmentalizes the extracted answer into the smallest unit (morpheme) having meaning in the language, and classifies the morpheme based on a type of a part of a speech. Thereafter, the extraction unit 12 lists morphemes of nouns among the classified morphemes. The extraction unit 12 stores the list (extracted information) in the storage device 20. Specifically, each of the organization name and the news title in the extracted answer (extracted information) is decomposed into nouns, and a noun list is generated.

When the user uses the user interface 41 for analysis first, the analysis unit 14 executes various analysis functions by using the extracted information (extracted answer and list) extracted based on the answer information and obtains an analysis result. Next, the analysis unit 14 stores the analysis result in the storage device 20.

The analysis functions include, for example, a filter function, a keyword search function, a word appearance frequency display function, a transition display function, a news display function, a news organization display function, a security incident type display function, a news detail display function, or the like.

For example, the filter function narrows the organization that has caused the security incident, narrows the type of the security incident, narrows a year and month to be analyzed, or the like.

For example, the keyword search function searches for a keyword using an organization name, a news title, an abstract of news, or the like as a key and presents the news to the user. A function may be included for displaying a list of keywords with a high search frequency and presenting news attracting attention to the user.

For example, the word appearance frequency display function visualizes a frequency of the included word (word cloud). By decomposing the organization name into nouns and highlighting a word with a high frequency, a difference in notation of the organization name can be absorbed.

The transition display function displays a transition of the number of cases for each type of the security incident. For example, a horizontal axis represents time series, and the number of cases for each type is vertically displayed as a bar graph. In this way, the user can grasp when and what type of security incident has frequently occurred.

The news display function displays a news list. For example, news regarding the same organization are collected and displayed in time series. In a case where the news are across a plurality of days, the news in a period are collectively displayed. The displayed information may be exported.

The news organization display function displays a news organization list. For example, a breakdown of the news organizations is compactly visualized by a horizontally long bar graph.

The security incident type display function displays the type of the security incident. For example, a breakdown of the security incidents is compactly visualized as a horizontally long bar graph, for each type.

The news detail display function displays further detailed information, about the displayed news. The detailed information may be exported with a URL, for example.

The various analysis functions described above are analyzed by the user, by using the user interface 41 displayed on the output device 40. The user operates the user interface 41 by using an input device (not illustrated). The input device is, for example, a device such as a touch panel, a mouse, or a keyboard.

The output information generation unit 15 generates the output information for causing the user interface 41 to output, based on the analysis result of the analysis unit 14. Thereafter, the output information generation unit 15 outputs the output information to the output device 40.

### The User Interface Will be Described in Detail.

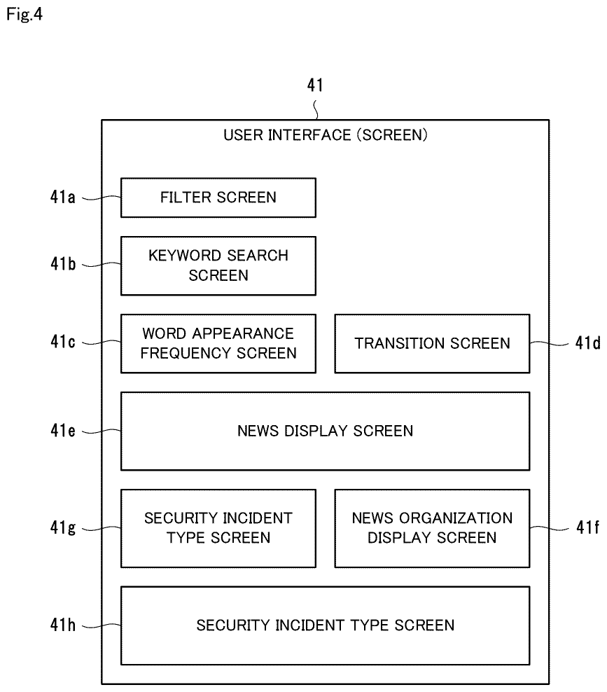

FIG. 4 is a diagram for explaining an example of the user interface. In the example in FIG. 4, the user interface displays at least any one or more of a filter screen 41a for executing the filter function, a keyword search screen 41b for executing the keyword search function, a word appearance frequency screen 41c for executing the word appearance frequency function, a transition screen 41d for executing the transition display function, a news display screen 41e for executing the news display function, a news organization display screen 41f for executing the news organization display function, a security incident type screen 41g for executing the security incident type display function, and a news detail display screen 41h for executing the news detail display function.

In addition, on the user interface, two or more of the filter screen 41a, the keyword search screen 41b, the word appearance frequency screen 41c, the transition screen 41d, the news display screen 41e, the news organization display screen 41f, the security incident type screen 41g, and the news detail display screen 41h are displayed side by side. Arrangement of each screen is not limited to that in the example in FIG. 4.

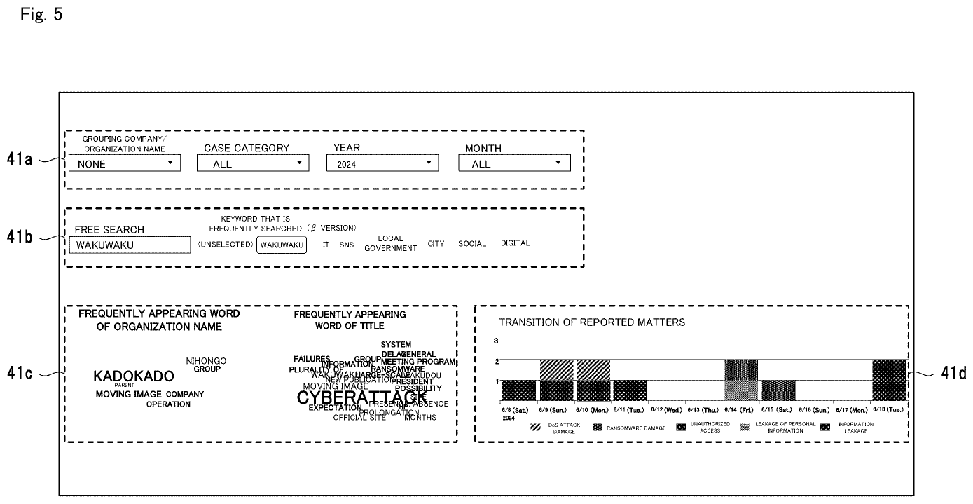

FIG. 5 is a diagram for explaining the filter screen, the keyword search screen, the word appearance frequency screen, and the transition screen. Arrangement of each screen is not limited to that in the example in FIG. 5.

The filter screen 41a is a screen that displays a filter for narrowing display content. In the example in FIG. 5, a pull-down menu (a combo box) is arranged that is used for achieving grouping of the organizations, narrowing based on the type of the security incident (a category of a case), narrowing based on the year (year), and narrowing based on the month (month).

In the grouping of the organizations, organizations designated by a security management department are grouped, based on the noun list of the organization name made by the extraction unit 12. For example, in a case where “A” is contained in common in a company name of a company A, an abbreviation of the company A, and a subcompany name of the company A, organizations having “A” included in the noun list are grouped as the company A.

In the menu of narrowing based on the type of the security incident, “all”, “DoS attack damage”, “ransomware damage”, “unauthorized access”, and “information leakage” can be selected. “All” indicates that “DOS attack damage”, “ransomware damage”, “unauthorized access”, and “information leakage” are set as targets to be narrowed.

The type of the security incident is determined by analyzing the news related to the target security incident and the abstract of the news, by using the generative AI or the like.

In a case where the type of the security incident is “information leakage”, it is determined whether a title of the news and an abstract of the news include a sentence from which news about personal information or customer information can be estimated, and determines whether the news is “news in which the personal information or the customer information is leaked” or “news regarding the information leakage from which the leakage of the personal information or the customer information cannot be confirmed”. For example, the determination is made based on whether the news title includes the personal information, the customer information, the user information, or the like. Then, in a case where the personal information or the customer information is included, in addition, narrowing based on “the leakage of the personal information and the customer information” and “the information leakage that does not include the personal information and the customer information” may be performed.

In the menu of narrowing based on the year and the month, “year”, “month”, “quarter”, “first half”, and “second half” can be selected. The year and the month are determined based on occurrence date and time information related to the target security incident.

The keyword search screen 41b is used to display keyword search. In the example in FIG. 5, a free search and a keyword that is frequently searched are arranged.

In the free search, with the input keyword, the information stored in the storage device 20 (organization related to security incident, body text of news, title of news, and abstract of news) is referred to, and the organization, the body text of the news, the title of the news, and the abstract of the news are searched.

In the keyword that is frequently searched, keywords searched in the free search are counted by the number of searches, and the keywords are displayed in descending order of the number of searches. As a result, it is possible to grasp what type of security incident other employees are interested in, in the organization, and it is possible to know a security incident that has attracted attention. By clicking each keyword, the keyword can be freely searched.

Since the news is required to be new, a keyword that is most recently searched may be selected as a top, by adjusting the number of keyword searches. As indicated in the expression 1, it is considered to adjust the number of keyword searches KWn.

$$KWn = RKWn - ( RKWn \times SPN / Cn ) \qquad ( Expression 1 )$$

KWn: the number of keyword searches
RKWn: actual number of keyword searches
SPN: the number of elapsed days from the date of search
Cn: a constant, for example, 7 days or the like

The word appearance frequency screen 41c is used to display an appearance frequency of a word. In the example in FIG. 5, a frequently appearing word of the organization name of which the frequency is visualized (word cloud) and a frequently appearing word of the news title are arranged.

Regarding the frequently appearing word of the organization name, since there is a case where the organization name is differently called depending on the news organization, if the generative AI is caused to extract the frequently appearing word of the organization name, the notation of the organization name differs. For example, in a case of a cabinet cyber security center, a notation differs, as the cabinet cyber security center (NISC), the NISC, or the like.

The frequently appearing word of the organization name is obtained by calculating data obtained by decomposing the organization name into nouns in an appearance frequently order, based on the information filtered by the filter function and the keyword search function, in order to automatically grasp the organization name of which the security incidents are frequently reported. For example, the frequently appearing word of the organization name within a range filtered by the year and month or within a range limited by a keyword such as ransomware is analyzed. In the frequently appearing word of the organization name, by highlighting a noun that is frequently reported, a noun commonly used for the organization name can be grasped. As a result, the user can quickly grasp which organization is frequently reported the security incident (whether to attract public attention).

Specifically, in the frequently appearing word of the organization name in FIG. 5, since “KADOKADO” and “nihongo” are highlighted, it can be inferred that the security incidents regarding “KADOKADO” and “nihongo” are reported.

Similarly to the organization name, the frequently appearing word of the title is highlighted in a frequency order from data obtained by decomposing a text included in the title of the news into nouns, based on the information filtered by the filter function and the keyword search function. As a result, what type of security incident attracts public attention can be quickly grasped.

Specifically, in the frequently appearing word of the title in FIG. 5, “WAKUWAKU moving image” and “cyberattack” are highlighted, it can be inferred that security incidents regarding “WAKUWAKU moving image” and “cyberattack” are frequently reported.

The transition screen 41d is used to display a transition of the number of cases for each type of the reported security incident. In the example in FIG. 5, a time chart indicating a transition of the reported security incidents (cases) in time series is arranged.

In the transition of the reported security incidents (cases), the classified type (category) of the security incident is displayed as the time chart, based on the information filtered by the filter function and the keyword search function. It is possible to grasp which security incident is frequently reported and whether there is a security incident that is intensively reported in a specific period. As a result, a long-term tendency of the security incident can be grasped.

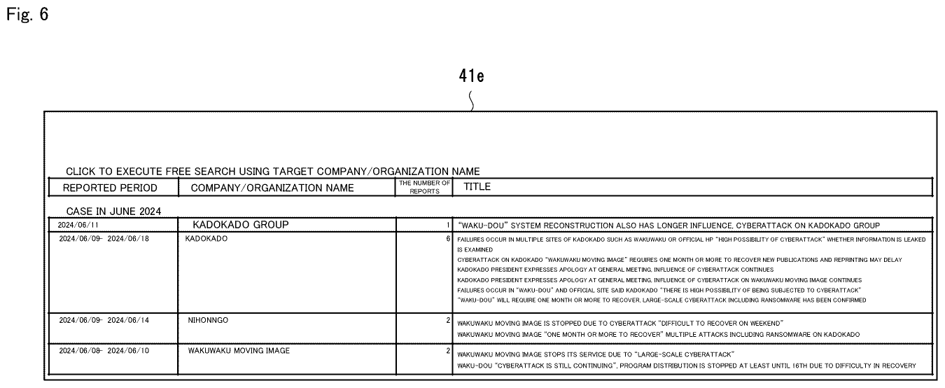

The news display screen 41e is used to display a news list. FIG. 6 is a diagram for explaining a news display screen. In the example in FIG. 6, as display items of the news display screen 41e, a list of one or more rows associated with “a reported period”, “a company/organization name”, “the number of reports”, and “a title” is arranged (displayed).

In a case where news is reported over a plurality of days, and in a case where the news is arranged in a list based on only reported days, since the same organization name (company/organization name) and a security incident (case) on different reported days are displayed in different rows, it is difficult to confirm the security incident of the same organization name.

By performing summarizing based on the reported period (period from the first report to the latest report of the same organization), visibility is enhanced. In the reported period, when the security incidents (cases) are only listed, this becomes monotonous, and accordingly, by counting the number of security incidents for each month (dividing the security incidents for each month with titles), necessary information in a specific period can be easily found.

In the example in FIG. 6, security incidents (cases) in June 2024 are displayed. A date and time when the security incident in June 2024 has occurred (“reported period”), an organization name associated with KADOKADO group (“company/organization name”), the number of reports (“the number of reports”), and a title of news (“title”) are displayed in association with each other.

When clicking a row in FIG. 6, free search may be performed with the organization name (company/organization name) in the clicked row (drill down function (deep search function)). For example, in a case of “KADOKADO nihongo”, a row of “KADOKADO nihongo” is clicked to perform free search (automatic execution). This drill down function is used in a case where long-term security incidents (cases) are investigated.

The user can widen a search range by adjusting the keyword of the free search. For example, by deleting “nihongo” from “KADOKADO nihongo” and widening the range to “KADOKADO”, and free search is performed.

In addition, in the news display screen, a function for exporting news related to a title, when clicking the title described in “title”, is provided. The data of the news is downloaded, for example, in a format of comma separated values (csv) or the like. As a result, the user can efficiently use the downloaded data to create a report and analysis data.

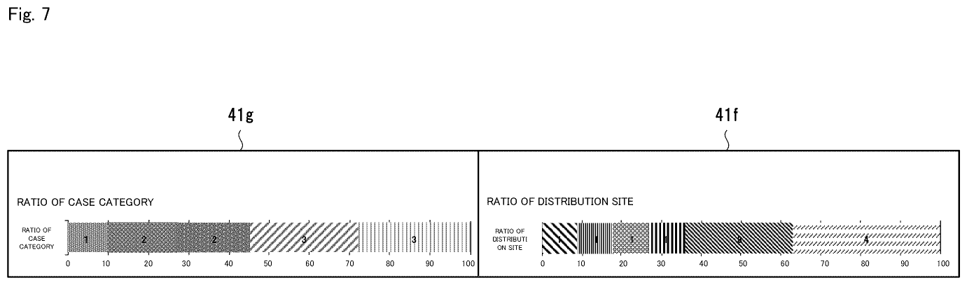

The security incident type screen 41g is used to display a ratio of a case category. The news organization display screen 41f is used to display a breakdown of a news organization. FIG. 7 is a diagram for explaining the security incident type screen and the news organization display screen. In the example in FIG. 7, the ratio of the case category (security incident type) and a ratio of a distribution site are arranged.

The ratio of the case category (security incident type) is used to display the type of the security incident. The ratio of the security incident type (case category) is displayed as a bar graph, based on the information filtered by the filter function and the keyword search function. As a result, the user can easily grasp which security incident frequently occurs.

The ratio of the distribution site is used to display a ratio of the distribution site or the like. The ratio of the distribution site or the like is displayed as a bar graph, based on the information narrowed by the filter function and the keyword search function. From the ratio of the distribution site, in a case where the news of the security incident is narrowed according to a specific organization (company/organization) or a specific case category, by the filter function, the user can grasp which news organization frequently reports the filter target. The user can know from which news organization necessary information can be easily obtained after browsing.

However, the display of the ratio is not limited to the bar graph. For example, a pie chart may be used. An advantage of using the bar graph is that a margin can be reduced with a low height in the bar graph, although a large margin is created, a height is needed, and a large unnecessary margin is made in a dashboard in the pie chart.

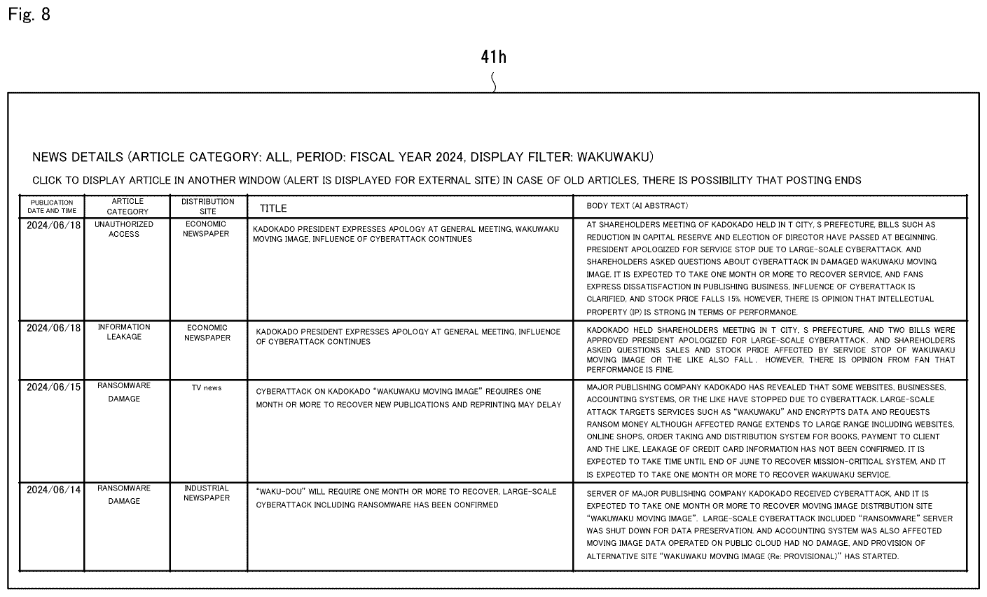

The news detail display screen 41h is used to display details of the news. FIG. 8 is a diagram for explaining the news detail display screen. In the example in FIG. 8, as display items of the news detail display screen 41h, a list of one or more rows associated with “a published date and time”, “an article category”, “a distribution site”, “a title”, and “a body text (AI abstract)” is arranged (displayed).

Since the input abstract is text data with no line feed and lacks readability, by automatically inserting a line feed when a point (.) and a punctuation (,) after certain number or more of characters appear in the news detail display screen 41h, it is possible to improve readability of the abstract for the user.

When clicking the row in FIG. 8, the clicked news is opened in another window (drill down function (deep search function)). A function for exporting a news related to a title is provided. The data of the news is downloaded, for example, in a format of comma separated values (csv) or the like. The data to be downloaded may be generated in a state where a URL is added. As a result, the user can efficiently use the downloaded data to create a report and analysis data.

### [Device Operation]

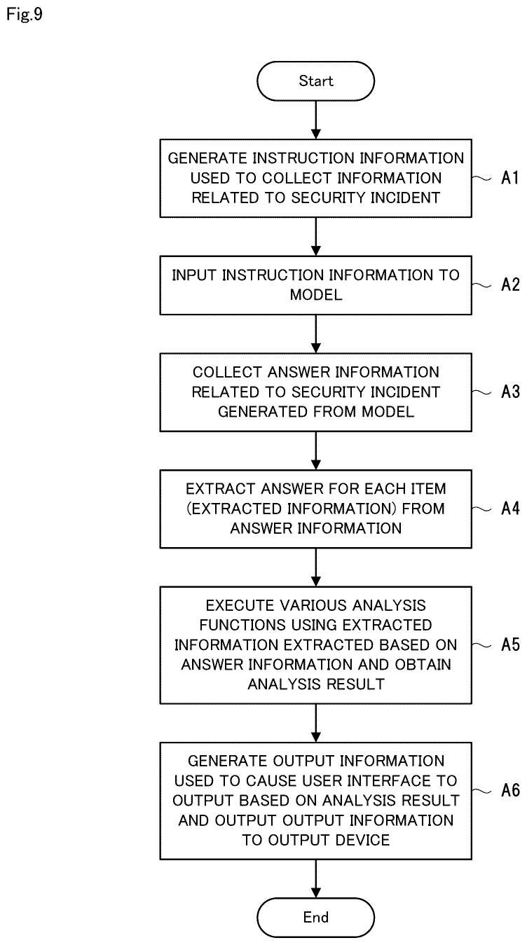

Next, an operation of the information processing apparatus according to the example embodiment will be described with reference to FIG. 9. FIG. 9 is a diagram for explaining the operation of the information processing apparatus. In the following description, the drawings are appropriately referred. In the example embodiment, by operating the information processing apparatus, an information processing method is implemented. Therefore, description of the information processing method according to the example embodiment is substituted with the description of the operation of the information processing apparatus below.

As illustrated in FIG. 9, first, the generation unit 13 generates the instruction information used to collect the information related to the security incident (step A1).

Next, the collection unit 11 inputs the instruction information used to collect the information related to the security incident, into the model such as the generative AI 31 (step A2).

Next, the collection unit 11 collects the answer information related to the security incident generated by the model, from the model such as the generative AI 31 (step A3).

Next, the extraction unit 12 acquires the answer information from the collection unit 11 or the storage device 20 and extracts the answer (extracted information) for each item from the acquired answer information (step A4). Moreover, in step A4, the extraction unit 12 generates the list (extracted information).

Next, when the user performs analysis by using the user interface 41, the analysis unit 14 executes various analysis functions (filter function, keyword search function, word appearance frequency display function, transition display function, news display function, news organization display function, security incident type display function, and news detail display function) by using the extracted information (extracted answer and list) extracted based on the answer information and obtains an analysis result (step A5).

Various analysis functions are analyzed by the user, by using the user interface 41 displayed on the output device 40. The user operates the user interface 41 by using an input device (not illustrated).

Next, the output information generation unit 15 generates the output information for causing the user interface 41 to output, based on the analysis result of the analysis unit 14. Thereafter, the output information generation unit 15 outputs the output information to the output device 40 (step A6).

### [Effect of Example Embodiment]

As described above, according to the example embodiment, since the information related to the security incident is collected by the model, it is possible to efficiently collect the information related to the security incident. In addition, it is possible to present the information related to the security incident to the user.

### [Program]

It is sufficient that a program in the example embodiment be a program that causes a computer to execute steps A1 to A6 illustrated in FIG. 9. When the program is installed and executed in the computer, the information processing apparatus and the information processing method according to the example embodiment can be achieved. In this case, a processor of the computer functions as the generation unit 13, the collection unit 11, the extraction unit 12, the analysis unit 14, and the output information generation unit 15 and executes processing.

The program according to the example embodiment may be executed by a computer system constructed by a plurality of computers. In this case, for example, each computer may function as any one of the generation unit 13, the collection unit 11, the extraction unit 12, the analysis unit 14, and the output information generation unit 15.

### [Physical Configuration]

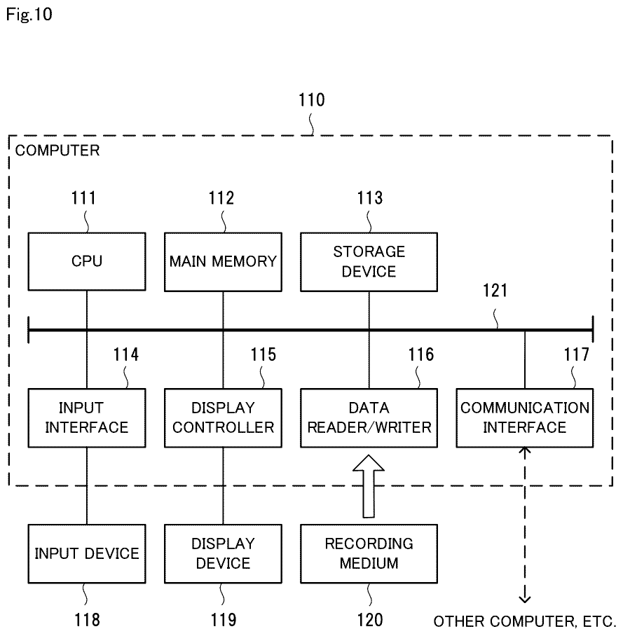

Here, the computer that achieves the information processing apparatus by executing the program in the example embodiment will be described with reference to FIG. 10. FIG. 10 is a diagram for explaining an example of a computer that achieves the information processing apparatus according to an example embodiment.

As illustrated in FIG. 10, a computer 110 includes a central processing unit (CPU) 111, a main memory 112, a storage device 113, an input interface 114, a display controller 115, a data reader/writer 116, and a communications interface 117. These units are data-communicably connected to each other via a bus 121. The computer 110 may include a GPU or an FPGA in addition to the CPU 111 or instead of the CPU 111.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. Then, the program in the example embodiment may be distributed on the Internet connected via the communications interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result of the computer 110 into the recording medium 120. The communications interface 117 mediates data transmission between the CPU 111 and another computer.

Specific examples of the recording medium 120 include general-purpose semiconductor storage devices such as Compact Flash (CF) (registered trademark) and a secure digital (SD), a magnetic recording medium such as a flexible disk (flexible disk), and an optical recording medium such as a compact disk read only memory (CD-ROM).

The information processing apparatus 10 in the example embodiment can also be achieved using hardware related to each unit, for example, an electronic circuit, instead of a computer in which a program is installed. Moreover, a part of the information processing apparatus 10 may be achieved by a program, and the remaining part may be achieved by hardware. In the example embodiment, the computer is not limited to the computer illustrated in FIG. 10.

### [Supplementary Note]

With regard to the above example embodiment, the following Supplementary Notes are further disclosed. Some or all of the above-described example embodiment can be expressed by (Supplementary Note 1) to (Supplementary Note 24) described below, but are not limited to the following description.

### (Supplementary Note 1)

An information processing apparatus including:
a collection unit for inputting instruction information used to collect information related to a security incident, into a model that generates and outputs an answer based on an input instruction and causing the model to collect answer information related to the security incident; and
an extraction unit for extracting information indicating the security incident and information indicating an organization to be a subject of the security incident, based on the answer information.

### (Supplementary Note 2)

The information processing apparatus according to supplementary note 1, in which
the instruction information includes determination condition information used to determine whether the security incident is a security incident, subject extraction information used to extract the organization to be the subject of the security incident, and type determination information used to determine a type of the security incident.

### (Supplementary Note 3)

The information processing apparatus according to supplementary note 2, in which
the type of the security incident is information leakage, a ransomware damage, a denial of service (DoS) attack damage, and an unauthorized access.

### (Supplementary Note 4)

The information processing apparatus according to supplementary note 2 or 3, in which
the instruction information further includes information for extracting a date and time when the security incident has occurred and information for extracting a date and time when an announcement regarding the security incident has been made.

### (Supplementary Note 5)

The information processing apparatus according to any one of supplementary notes 2 to 4, in which
the instruction information further includes format information used to cause the model to answer according to a preset format.

### (Supplementary Note 6)

The information processing apparatus according to any one of supplementary notes 1 to 5, further including:
analysis means for analyzing information extracted based on the answer information; and
output information generation means for generating output information used to cause a user interface to output, based on an analysis result of the analysis means.

### (Supplementary Note 7)

The information processing apparatus according to supplementary note 6, in which
the user interface displays at least one or more of a filter screen for displaying a filter that narrows display content, a keyword search screen for displaying keyword search, a word appearance frequency screen for displaying an appearance frequency of a word, a transition screen for displaying a transition of the number of cases for each type of a reported security incident, a news display screen for displaying a news list, a news organization display screen for displaying a breakdown of a news organization, a security incident type screen for displaying the type of the security incident, and a news detail display screen for displaying details of news.

### (Supplementary Note 8)

The information processing apparatus according to supplementary note 7, in which
on the user interface, two or more of the filter screen, the keyword search screen, the word appearance frequency screen, the transition screen, the news display screen, the news organization display screen, the security incident type screen, and the news detail display screen are displayed side by side.

### (Supplementary Note 9)

An information processing method performed by an information processing apparatus, including:
inputting instruction information used to collect information related to a security incident, into a model that generates and outputs an answer based on an input instruction and causing the model to collect answer information related to the security incident; and
extracting information indicating the security incident and information indicating an organization to be a subject of the security incident, based on the answer information.

### (Supplementary Note 10)

The information processing method according to supplementary note 9, in which
the instruction information includes determination condition information used to determine whether the security incident is a security incident, subject extraction information used to extract the organization to be the subject of the security incident, and type determination information used to determine a type of the security incident.

### (Supplementary Note 11)

The information processing method according to supplementary note 10, in which
the type of the security incident is information leakage, a ransomware damage, a denial of service (DOS) attack damage, and an unauthorized access.

### (Supplementary Note 12)

The information processing method according to supplementary note 10 or 11, in which
the instruction information further includes information for extracting a date and time when the security incident has occurred and information for extracting a date and time when an announcement regarding the security incident has been made.

### (Supplementary Note 13)

The information processing method according to any one of supplementary notes 10 to 12, in which
the instruction information further includes format information used to cause the model to answer according to a preset format.

### (Supplementary Note 14)

The information processing method according to any one of supplementary notes 9 to 13, performed by the information processing apparatus, further including:
analyzing information extracted based on the answer information; and
generating output information used to cause a user interface to output, based on an analysis result.

### (Supplementary Note 15)

The information processing method according to supplementary note 14, in which
the user interface displays at least one or more of a filter screen for displaying a filter that narrows display content, a keyword search screen for displaying keyword search, a word appearance frequency screen for displaying an appearance frequency of a word, a transition screen for displaying a transition of the number of cases for each type of a reported security incident, a news display screen for displaying a news list, a news organization display screen for displaying a breakdown of a news organization, a security incident type screen for displaying the type of the security incident, and a news detail display screen for displaying details of news.

### (Supplementary Note 16)

The information processing method according to supplementary note 15, in which
on the user interface, two or more of the filter screen, the keyword search screen, the word appearance frequency screen, the transition screen, the news display screen, the news organization display screen, the security incident type screen, and the news detail display screen are displayed side by side.

### (Supplementary Note 17)

A program for causing a computer to execute processing including:
inputting instruction information used to collect information related to a security incident, into a model that generates and outputs an answer based on an input instruction and causing the model to collect answer information related to the security incident; and
extracting information indicating the security incident and information indicating an organization to be a subject of the security incident, based on the answer information.

### (Supplementary Note 18)

The program according to supplementary note 17, in which
the instruction information includes determination condition information used to determine whether the security incident is a security incident, subject extraction information used to extract the organization to be the subject of the security incident, and type determination information used to determine a type of the security incident.

### (Supplementary Note 19)

The program according to supplementary note 18, in which
the type of the security incident is information leakage, a ransomware damage, a denial of service (DoS) attack damage, and an unauthorized access.

### (Supplementary Note 20)

The program according to supplementary note 18 or 19, in which
the instruction information further includes information for extracting a date and time when the security incident has occurred and information for extracting a date and time when an announcement regarding the security incident has been made.

### (Supplementary Note 21)

The program according to any one of supplementary notes 18 to 20, in which
the instruction information further includes format information used to cause the model to answer according to a preset format.

### (Supplementary Note 22)

The program according to any one of supplementary notes 17 to 21, for causing the information processing apparatus to execute processing, further including:
analyzing information extracted based on the answer information; and
generating output information used to cause a user interface to output, based on an analysis result.

### (Supplementary Note 23)

The program according to supplementary note 22, in which
the user interface displays at least one or more of a filter screen for displaying a filter that narrows display content, a keyword search screen for displaying keyword search, a word appearance frequency screen for displaying an appearance frequency of a word, a transition screen for displaying a transition of the number of cases for each type of a reported security incident, a news display screen for displaying a news list, a news organization display screen for displaying a breakdown of a news organization, a security incident type screen for displaying the type of the security incident, and a news detail display screen for displaying details of news.

### (Supplementary Note 24)

The program according to supplementary note 23, in which
on the user interface, two or more of the filter screen, the keyword search screen, the word appearance frequency screen, the transition screen, the news display screen, the news organization display screen, the security incident type screen, and the news detail display screen are displayed side by side.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### INDUSTRIAL APPLICABILITY

According to the above description, it is possible to efficiently collect the information related to the security incident. This is also useful in fields where analysis of the security incidents is needed.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus comprising:
at least one memory storing instructions; and
at least one processor configured to execute the instructions to:
input instruction information used to collect information related to a security incident, into a model that generates and outputs an answer based on an input instruction and causing the model to collect answer information related to the security incident; and
extract information indicating the security incident and information indicating an organization to be a subject of the security incident, based on the answer information.

2. The information processing apparatus according to claim 1, wherein
the instruction information includes determination condition information used to determine whether the security incident is a security incident, subject extraction information used to extract the organization to be the subject of the security incident, and type determination information used to determine a type of the security incident.

3. The information processing apparatus according to claim 2, wherein
the type of the security incident is information leakage, a ransomware damage, a denial of service (DoS) attack damage, and an unauthorized access.

4. The information processing apparatus according to claim 2, wherein
the instruction information further includes information for extracting a date and time when the security incident has occurred and information for extracting a date and time when an announcement regarding the security incident has been made.

5. The information processing apparatus according to claim 2, wherein
the instruction information further includes format information used to cause the model to answer according to a preset format.

6. The information processing apparatus according to claim 1, further comprising:
analysis means for analyzing information extracted based on the answer information; and
output information generation means for generating output information used to cause a user interface to output, based on an analysis result of the analysis means.

7. The information processing apparatus according to claim 6, wherein
the user interface displays at least one or more of a filter screen for displaying a filter that narrows display content, a keyword search screen for displaying keyword search, a word appearance frequency screen for displaying an appearance frequency of a word, a transition screen for displaying a transition of the number of cases for each type of a reported security incident, a news display screen for displaying a news list, a news organization display screen for displaying a breakdown of a news organization, a security incident type screen for displaying the type of the security incident, and a news detail display screen for displaying details of news.

8. The information processing apparatus according to claim 7, wherein
on the user interface, two or more of the filter screen, the keyword search screen, the word appearance frequency screen, the transition screen, the news display screen, the news organization display screen, the security incident type screen, and the news detail display screen are displayed side by side.

9. An information processing method performed by an information processing apparatus, comprising:
inputting instruction information used to collect information related to a security incident, into a model that generates and outputs an answer based on an input instruction and causing the model to collect answer information related to the security incident; and
extracting information indicating the security incident and information indicating an organization to be a subject of the security incident, based on the answer information.

10. A non-transitory program for causing a computer to execute processing comprising:
inputting instruction information used to collect information related to a security incident, into a model that generates and outputs an answer based on an input instruction and causing the model to collect answer information related to the security incident; and
extracting information indicating the security incident and information indicating the organization to be the subject of the security incident, based on the answer information.
